(19) United States
(12) Patent Application Publication
(10) Pub. No.: US 2008/0028925 A1
(43) Pub. Date: Feb. 7, 2008

(54) Piston-cylinder unit

(76) Inventor: Markus Lingemann, Bochum (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/809,880

(22) Filed: Jun. 1, 2007

(30) Foreign Application Priority Data
Jun. 1, 2006 (DE) 10 2006 025 696.4

(51) Int. Cl. F15B 15/14

(52) U.S. Cl. 92/6 R

(57) ABSTRACT

A piston-cylinder unit has a cylinder, at least one pressure chamber, a piston that can be moved in the cylinder and that delimits the at least one pressure chamber, at least one pressure port leading to the pressure chamber, a pressure-limiting line in the piston leading from one side of the pressure chamber to the other side of the piston, a valve element, and a pre-tensioning element. The pressure-limiting line is associated with the valve element that is acted upon by the pre-tensioning element.

### CROSS-REFERENCE TO RELATED APPLICATIONS

This application claims priority of German Patent Application No. 10 2006 025 696.4 filed Jun. 1, 2006, the disclosures of which are incorporated herein by reference.

### BACKGROUND OF THE INVENTION

The present invention relates to a piston-cylinder unit.

Piston-cylinder units with a piston that can be moved in a cylinder are known from the state of the art. For example, in such a piston-cylinder unit the piston may be connected to a piston rod that is coupled to a steering linkage. The piston may be moved by a hydraulic fluid flowing into a pressure chamber.

One object of the present invention is to regulate the pressure exerted on such piston.

### BRIEF SUMMARY OF THE INVENTION

A piston-cylinder unit has a cylinder, at least one pressure chamber, a piston that can be moved in the cylinder and that delimits the at least one pressure chamber, at least one pressure port leading to the pressure chamber, a pressure-limiting line in the piston leading from one side of the pressure chamber to the other side of the piston, a valve element, and a pre-tensioning element. The pressure-limiting line is associated with the valve element that is acted upon by the pre-tensioning element.

The pre-tensioning element acts upon the valve element towards a valve seat in such a way that the pressure-limiting line is closed. The pressure in the pressure chamber acts upon the effective surface of the valve element. Thus, a force is exerted onto the valve element. As soon as the force resulting from the pressure in the pressure chamber exceeds the force of the pre-tensioning element, the valve element is pushed out of the valve seat and hydraulic fluid flows out of the pressure chamber through the pressure-limiting line into the piston, as a result of which the pressure in the pressure chamber drops. An advantage of the invention is that the pressure prevailing in the pressure chamber can be regulated.

According to one embodiment, the pre-tensioning element is a slit locking ring that surrounds the piston in a circumferential direction. The slit locking ring, which is made of metal, is accommodated, for example, in a circumferential groove so that it cannot inadvertently move along the piston. The locking ring is wear-resistant and has a long service life.

According to another embodiment, the pre-tensioning element is an elastic sealing ring that surrounds the piston in a circumferential direction.

Preferably, although not necessarily, the pre-tensioning element comprises an outside facing away from the valve element, and the cylinder comprises an inner wall, the outside of the pre-tensioning element lying against the inner wall of the cylinder. The pre-tensioning element can push the valve element into the position in which the pressure-limiting line is closed and it can release the valve element, for example, when the inner diameter of the cylinder changes. Then, hydraulic fluid can flow through the pressure-limiting line so that the pressure prevailing in the pressure chamber can be reduced. Hence, the pre-tensioning element in cooperation with the inner wall of the cylinder constitutes an additional way to limit the pressure and it can be selected differently depending on the embodiment.

Advantages of this invention will become apparent to those skilled in the art from the following detailed description of the preferred embodiments, when read in light of the accompanying drawings.

### BRIEF DESCRIPTION OF THE DRAWINGS

FIG. 1 shows a schematic sectional view of a piston-cylinder unit; and

FIG. 2 shows a schematic sectional view of a part of a piston-cylinder unit according to the invention.

### DETAILED DESCRIPTION OF THE INVENTION

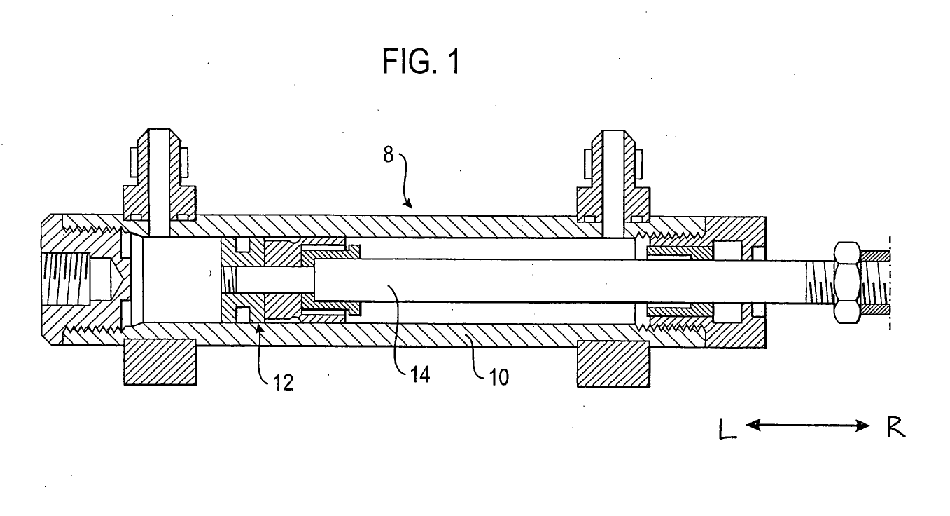

FIG. 1 schematically shows a piston-cylinder unit 8 that is, for example, part of a steering system. The piston-cylinder unit 8 has a cylinder 10 and a piston 12 that can be moved in the cylinder 10, the piston 12 being configured as a piston ring and being connected to a piston rod 14. The piston rod 14 extends from the end of the cylinder 10 on the right-hand side with respect to FIG. 1, and is connected, for example, to a steering linkage (not shown).

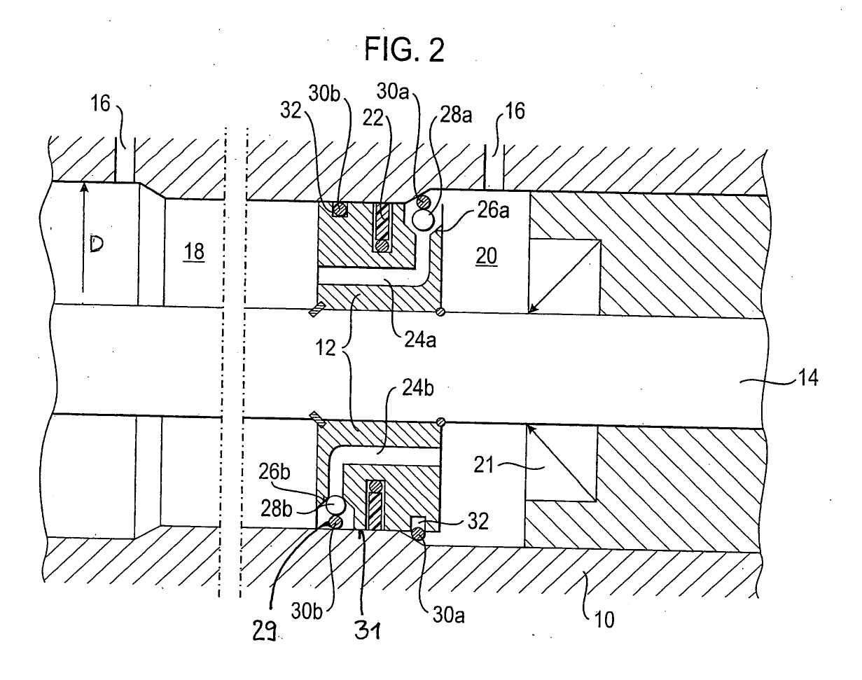

The cylinder 10 is provided with two pressure ports 16 through which a hydraulic fluid can be fed into a left-hand or a right-hand pressure chamber 18, 20 (see FIG. 2). In this manner, the piston 12 can be moved to the left (see L in FIG. 1) and to the right (see R in FIG. 1) between an end position on the left-hand side and an end position on the right-hand side. FIG. 2 shows the piston 12 near its end position on the right-hand side. The cylinder 10 has a changing inner diameter D that is larger in the area of the end positions of the piston 12 than in the working area, which lies between the end positions.

A sealing ring 21 is provided that seals each pressure chamber 18, 20 and a piston gasket 22 is also provided.

The piston 12 has two pressure-limiting lines 24a, 24b that connect the two pressure chambers 18, 20 to each other. The pressure-limiting lines 24a, 24b run from the appertaining pressure chamber 18, 20 first axially and subsequently radially, and they end in a valve seat 26a, 26b, each valve seat 26a, 26b receiving a valve element 28a, 28b that is acted upon in the radial direction by an appertaining pre-tensioning element 30a, 30b in such a way that the valve element 28a, 28b is held in the appertaining valve seat 26a, 26b.

The outside 29 of the pre-tensioning element 30a, 30b facing away from the valve element 28a, 28b lies against the inner wall 31 of the cylinder 10. The pre-tensioning element 30a, 30b is a slit locking ring or an elastic sealing ring, and it is arranged in a circumferential slit 32 in order to prevent an inadvertent movement in the axial direction.

The function of the piston-cylinder unit 8 will be discussed below.

If the piston 12 is to be moved out of its end position on the left-hand side (not shown), hydraulic fluid is fed in via the pressure port 16 on the left-hand side as seen in FIG. 2. The hydraulic fluid pushes the piston 12 to the right with respect to FIG. 2. The pressure in the pressure chamber 18 acts upon the effective surface of the valve element 28a. Thus, a force is exerted onto the valve element 28a. The pre-tensioning element 30a releases the valve element 28a once the force resulting from the pressure in the pressure chamber 18 exceeds the force of the pre-tensioning element 30a and when the piston 12 reaches the area of its end position (see FIG. 2) in which the inner diameter R of the cylinder 10 is larger than in the working area of the piston 12. As soon as the pre-tensioning element 30a releases the valve element 28a, the hydraulic fluid can flow through the pressure-limiting line 24a into the pressure chamber 20.

In this position, the pressure differential between the pressure chamber 18 and the pressure chamber 20 as well as the pre-tensioning element 30b still hold the pressure-limiting line 24b closed. After all, the valve element 28b is connected to the pressure chamber 20 in which less pressure prevails than in the pressure chamber 18.

If the piston 12 is to be moved out of the end position on the right-hand side with respect to FIG. 2, hydraulic fluid is fed into the pressure chamber 20 via the pressure port 16 on the right-hand side with respect to FIG. 2. The pressure in the pressure chamber 20 rises and the piston 12 is moved to the left with respect to FIG. 2. When the piston 12 is moved, the pre-tensioning element 30a is pushed towards the valve element 28a and it closes the pressure-limiting line 24a so that no hydraulic fluid can flow through the pressure-limiting line 24a. The valve element 28a then comes to lie against the valve seat 26a.

Near the end position on the left-hand side of the piston 12, in which the inner diameter R is enlarged, the pre-tensioning element 30b can release the valve element 28b. The pressure prevailing in the pressure chamber 20 acts upon the effective surface of the valve element 28b. Thus, a force is exerted onto the valve element 28b. The valve element 28b is released once this force exceeds the holding force of the pre-tensioning element 30b. As soon as the valve element 28b has been released, the hydraulic fluid can flow through the pressure-limiting line 24b into the pressure chamber 20. The pre-tensioning element 30a, which closes the pressure-limiting line 24a, still closes the pressure-limiting line 24a, since it is connected to the pressure chamber 18 where no pressure prevails.

Of course, it is also possible to enlarge the inner diameter R in the middle of the movement path of the piston 12 if a pressure limitation is desired in this area.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A piston-cylinder unit having
a cylinder,
at least one pressure chamber,
a piston that can be moved in said cylinder and that delimits said at least one pressure chamber,
at least one pressure port leading to said pressure chamber,
a pressure-limiting line in said piston leading from one side of said pressure chamber to the other side of said piston,
a valve element, and
a pre-tensioning element,
the pressure-limiting line being associated with said valve element that is acted upon by said pre-tensioning element.

2. The piston-cylinder unit according to claim 1, wherein said pre-tensioning element acts upon said valve element in a radial direction.

3. The piston-cylinder unit according to claim 1, wherein said pre-tensioning element is a slit locking ring that surrounds said piston in a circumferential direction.

4. The piston-cylinder unit according to claim 1, wherein said pre-tensioning element is an elastic sealing ring that surrounds said piston in a circumferential direction.

5. The piston-cylinder unit according to claim 1, wherein said pre-tensioning element comprises an outside facing away from said valve element and said cylinder comprises an inner wall, said outside of said pre-tensioning element lying against said inner wall of said cylinder.

6. The piston-cylinder unit according to claim 5, wherein said cylinder has a changing inner diameter.

7. The piston-cylinder unit according to claim 6, wherein said piston can take end positions and wherein said piston has a working area, said inner diameter of said cylinder being larger near said end position of said piston than in said working area.

8. The piston-cylinder unit according to claim 1, wherein a valve seat is provided and wherein said pressure-limiting line runs from the side of said pressure chambers first in the axial direction and subsequently in the radial direction, said valve element interacting with said valve seat that is formed at the end of the radially extending section of said pressure-limiting line.

9. The piston-cylinder unit according to claim 1, wherein a pressure chamber is formed on each side of said piston and said piston is provided with two pressure-limiting lines.
